(19) United States
(12) Patent Application Publication
(10) Pub. No.: US 2005/0033566 A1
(43) Pub. Date: Feb. 10, 2005

(54) Natural language processing method

(75) Inventor: Michio Aizawa, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/885,747

(22) Filed: Jul. 8, 2004

(30) Foreign Application Priority Data
Jul. 9, 2003 (JP) 2003-194543

(51) Int. Cl. G06F 17/28

(52) U.S. Cl. 704/5

(57) ABSTRACT

A sentence appended with information associated with a pause setting position is input (S201), and a morphological analysis process is applied to the sentence to divide the sentence into words and to determine parts of speech of respective words (S203). Part-of-speech sequences, each of which includes parts of speech of a total of N (N≧2) words before and after each word boundary, are obtained for respective word boundaries, and the frequencies of occurrence of arrangements of the parts of speech are calculated for respective groups of part-of-speech sequences with the same arrangements of parts of speech (S206). Pause counts, each of which indicates the number of times of setting of a pause setting position indicated by the pause setting position data between parts of speech in the part-of-speech sequence, are calculated for respective groups of the part-of-speech sequences with the same arrangements of parts of speech (S208). Pause insertability values are calculated using the frequencies of occurrence and pause counts for respective groups (S210).

### CLAIM OF PRIORITY

This application claims priority from Japanese Patent Application No. 2003-194543 filed on Jul. 9, 2003, which is hereby incorporated by reference.

### FIELD OF THE INVENTION

The present invention relates to a technique for setting a pause position in text.

### BACKGROUND OF THE INVENTION

In a text-to-speech synthesis system that converts text into speech, it is important for generation of natural, easy-to-understand synthetic speech to appropriately determine a pause position.

As a conventional method of determining a pause position, a technique for learning pause rules using a statistical method or the like is known (see Japanese Patent Laid-Open No. 2001-75584).

However, the conventional statistical method dominantly reflects the positions of commas in learning results. That is, a rule “insert a pause if a comma is located before this word” is generated with high priority. For this reason, a pause cannot be appropriately set in text with a very small number of commas.

### SUMMARY OF THE INVENTION

The present invention has been made in consideration of the aforementioned problems, and has as its object to provide a technique for learning pause rules irrespective of the number of commas.

In order to achieve the above object, for example, a natural language processing method of the present invention comprises the following arrangement.

That is, a natural language processing method comprising:

a reception step of receiving a sentence appended with information associated with a pause setting position;

a part-of-speech acquisition step of acquiring parts of speech of respective words in the sentence;

an acquisition step of acquiring frequencies of occurrence of arrangements of the parts of speech for respective part-of-speech sequence groups with the same arrangements of parts of speech corresponding to arrangements of the words;

a count step of counting the number of pause setting positions each of which is present between parts of speech in the part-of-speech sequence for respective part-of-speech sequence groups on the basis of the information associated with the pause setting position; and

a calculation step of calculating pause insertability values using the frequencies of occurrence and the number of setting positions for respective part-of-speech sequence groups.

In order to achieve the above object, for example, a natural language processing apparatus of the present invention comprises the following arrangement.

That is, a natural language processing apparatus comprising:

reception means for receiving a sentence appended with information associated with a pause setting position;

part-of-speech acquisition means for acquiring parts of speech of respective words in the sentence;

acquisition means for acquiring frequencies of occurrence of arrangements of the parts of speech for respective part-of-speech sequence groups with the same arrangements of parts of speech corresponding to arrangements of the words;

count means for counting the number of pause setting positions each of which is present between parts of speech in the part-of-speech sequence for respective part-of-speech sequence groups on the basis of the information associated with the pause setting position; and

calculation means for calculating pause insertability values using the frequencies of occurrence and the number of setting positions for respective part-of-speech sequence groups.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the basic arrangement of a natural language processing apparatus according to the first embodiment of the present invention;

FIG. 2 is a flowchart of a process for calculating (learning) the insertability of a pause into part-of-speech sequences of words in a sentence as a set of words;

FIG. 3 is a flowchart of a process for setting a pause in a general sentence using data indicating the insertabilities of pauses in part-of-speech sequences;

FIG. 4 shows an example of a text corpus;

FIG. 5 is a table showing a morphological analysis process result to a sentence “I have a pen and a pencil.” in the text corpus example in FIG. 4, and the presence/absence of a pause at each word boundary;

FIG. 6 is a table showing the frequency of occurrence and pause count of each group with respect to the sentence shown in FIG. 5;

FIG. 7 is a table showing a morphological analysis process result in step S301 and the insertability of a pause at each word boundary;

FIG. 8 shows an example of the configuration of a table that stores values indicating the insertabilities of pauses to respective part-of-speech sequences;

FIG. 9 is a table for explaining the insertability of a pause between the third and fourth parts of speech in a part-of-speech sequence when the length of the part-of-speech sequence is 5;

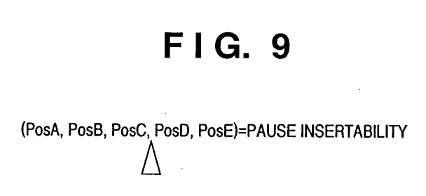

FIG. 10 is a view for explaining the insertability of a pause at the i-th word; and

FIG. 11 is a view for explaining an example for generating a text corpus appended with information associated with the insertion position of a pause by collecting sentences whose commas are removed from original sentences that appropriately include commas, and determining the positions of commas in the original sentences as pause positions.

### DETAILED DESCRIPTION OF THE PREFERRED EMBODIMENTS

Preferred embodiments of the present invention will now be described in detail in accordance with the accompanying drawings.

[First Embodiment]

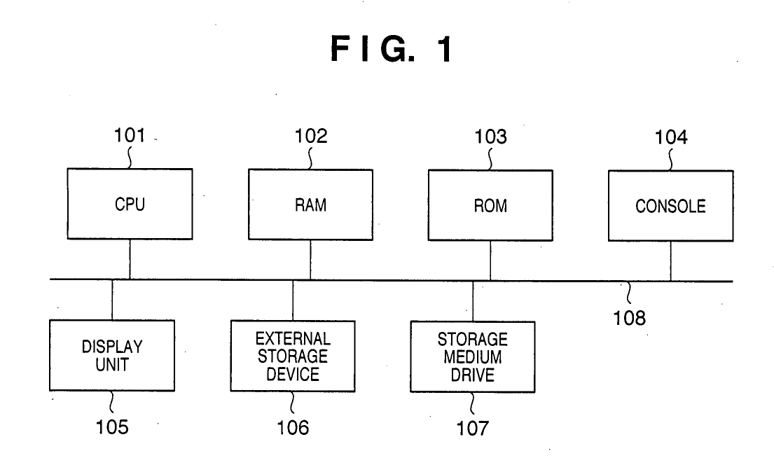

FIG. 1 is a block diagram showing the basic arrangement of a natural language processing apparatus according to this embodiment. Note that this embodiment will explain a natural language processing apparatus as a general personal computer (PC) or workstation, but dedicated hardware that implements a natural language process (to be described later) may be adopted.

Reference numeral 101 denotes a CPU which controls the overall apparatus using programs and data stored in a RAM 102 and ROM 103, and executes a natural language process (to be described later).

The RAM 102 comprises an area for temporarily storing programs and data loaded from an external storage device 106 or storage medium drive device 107, and also a work area used by the CPU 101 to execute various processes.

The ROM 103 stores programs and data required to launch and control this apparatus, and data of character codes and the like required to display characters on a display unit 105.

Reference numeral 104 denotes a console which comprises devices such as a keyboard, mouse, and the like used to make various inputs, and can issue various instructions to the CPU 101. The input character data and the like are temporarily stored in the RAM 102.

The display unit 105 comprises a CRT, liquid crystal display, or the like, can make various kinds of display, and can also display a sentence and the like (to be described later).

The external storage device 106 is represented by a large-capacity information storage device such as a hard disk drive device or the like, and can save an OS (operating system), and programs and data associated with a natural language process (to be described later).

The storage medium drive device 107 reads out programs and data stored in a storage medium such as a CD-ROM, DVD-ROM, or the like, and outputs them to the external storage device 106. Reference numeral 108 denotes a bus that interconnects the aforementioned units. Note that the arrangement of the natural language processing apparatus according to this embodiment is not limited to this, and a scanner for scanning a sentence printed on a paper sheet as digital data may be connected to the bus 108 via an interface (not shown), or a speech processor and loudspeaker used to output a processed natural language as speech may be connected to the bus 108 via an interface.

A network interface may be connected to the bus 108, and a network such as the Internet, LAN, or the like may be used to exchange various programs and data via the network interface.

A natural language process executed by the natural language processing apparatus with the above arrangement will be described below. A process for dividing an input sentence into words, and calculating (learning) the insertability of a pause into part-of-speech sequences of words will be explained first.

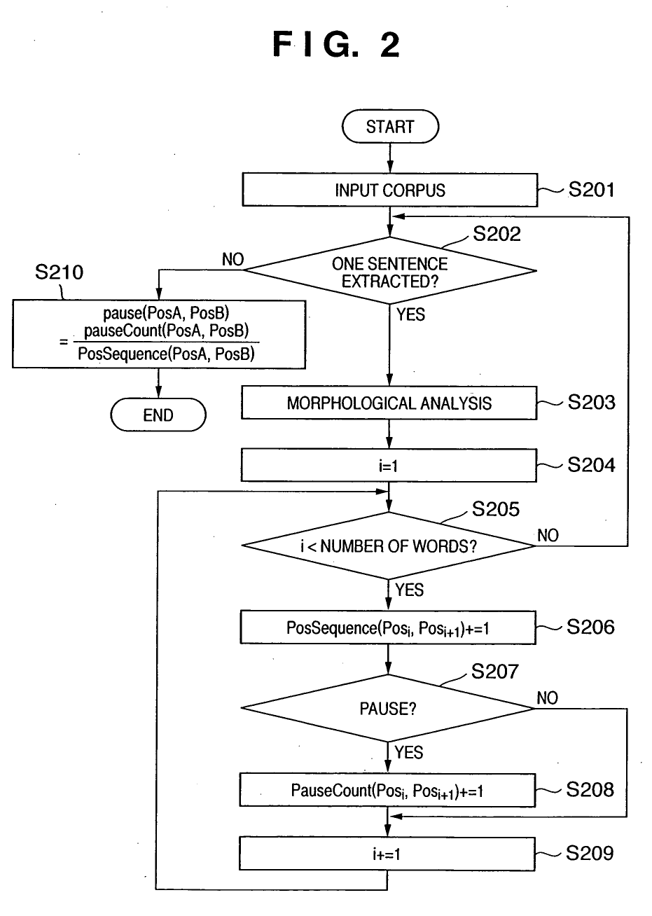

FIG. 2 is a flowchart of this process. A program according to the flowchart shown in FIG. 2 is loaded from the external storage device 105 or storage medium drive device 107 onto the RAM 102, and is executed by the CPU 101, so that the natural language processing apparatus according to this embodiment can implement the process to be described below.

The CPU 101 loads text corpus data appended with information associated with a pause setting (insertion) position from the external storage device 105 or storage medium drive device 107 onto the RAM 102 in response to an instruction from the console 104 (step S201).

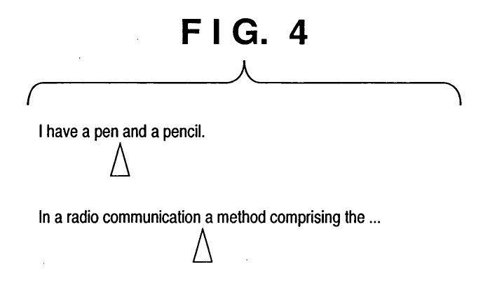

FIG. 4 shows an example of a text corpus. Pauses are present at positions indicated by triangular marks. That is, this text corpus is a set of sentences appended with information indicating pause setting positions. Since this text corpus is prepared on the basis of information actually uttered by a speaker, the way to insert a pause unique to the speaker can be learned using this text corpus.

Data of one unprocessed sentence is extracted onto an area of the RAM 102, which is different from the area on which the text corpus data is loaded, as a sentence to be processed, with reference to the text corpus data loaded onto the RAM 102 (step S202). If no data can be extracted, i.e., if the processes for all sentences are complete, the flow advances to step S210.

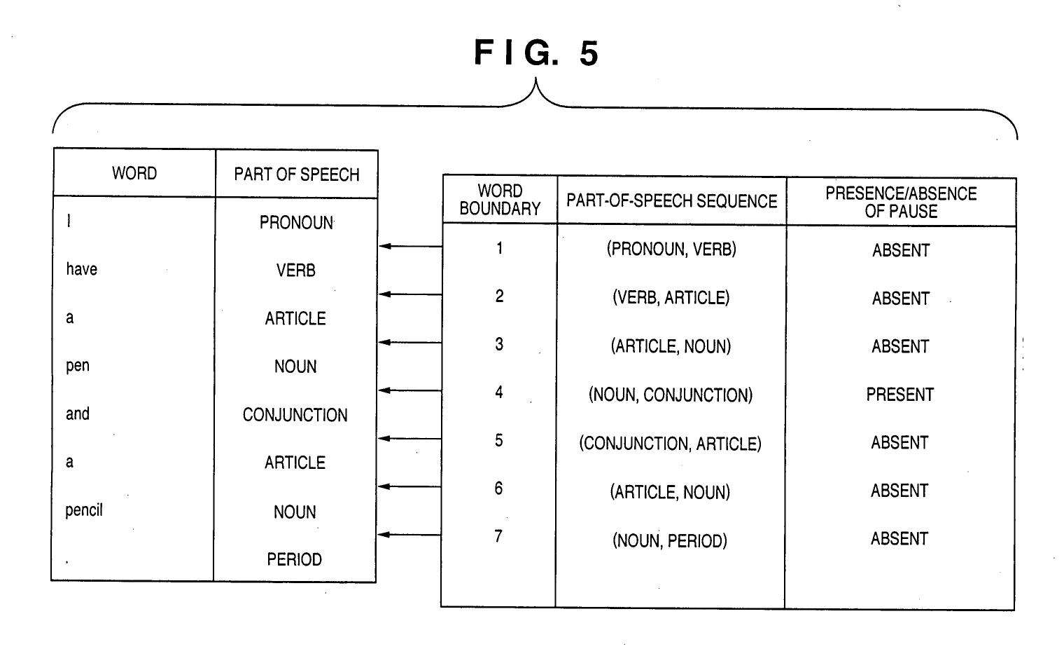

The sentence extracted in step S202 undergoes morphological analysis so as to divide the sentence into words, and to determine parts of speech of respective words (step S203). FIG. 5 shows the result of the morphological analysis process applied to one sentence “I have a pen and a pencil.” in the example of the text corpus in FIG. 4 in “word” and “part of speech” columns in FIG. 5. Since such morphological analysis process is a well-known technique, a description thereof will be omitted. Also, the result of the morphological analysis process is temporarily stored in the RAM 102.

The value of a variable i used in the subsequent steps is initialized to 1 (step S204). The value of the variable i is compared with the number of words divided by morphological analysis (step S205). In the example of FIG. 5, the number of words is 8. If the value of the variable i is smaller than the number of words, the flow advances to step S206; otherwise, the flow returns to step S202 to repeat the processes in step S202 and subsequent steps for the next sentence. Returning the flow to step S202 means that a process for one sentence is complete.

A part-of-speech sequence which includes parts of speech of a total of N words before and after the i-th word boundary is obtained, and a value indicating the frequency of occurrence of that part-of-speech sequence is incremented by 1 (step S206). Note that the i-th word boundary means a gap (boundary) between the i-th and (i+1)-th words. A case will be explained below wherein N=2 (one each words before and after the word boundary). For example, a process for the third word boundary in FIG. 5 increments, by 1, the value of PosSequence(article, noun) indicating the frequency of occurrence of a part-of-speech sequence (article, noun) which includes parts of speech of the third and fourth words (a, pen).

It is checked if a pause is present at the i-th word boundary (step S207). More specifically, it is determined if the part-of-speech sequence (a part-of-speech sequence which includes parts of speech of a total of N words before and after the i-th word boundary) has a pause setting position indicated by the text corpus between parts of speech. For example, the presence/absence of a pause at each word boundary in FIG. 5 is as shown in a field “presence/absence of pause” by comparing the pause position in FIG. 4.

If the part-of-speech sequence has a pause (i.e., it has a pause setting position indicated by the text corpus between parts of speech), a value indicating a pause count for the part-of-speech sequence which includes parts of speech of a total of N words before and after the i-th word boundary is incremented by 1 (step S208). In the example of FIG. 5, if the value of the variable i is 4, this step S208 is executed to increment the value of PauseCount(noun, conjunction) by 1.

Upon completion of the process in step S208, or if no pause is present at the i-th word boundary, the value of the variable i is incremented by 1 as the next process. That is, the aforementioned process for the next word boundary (that for the variable (i+1) in place of i) is executed.

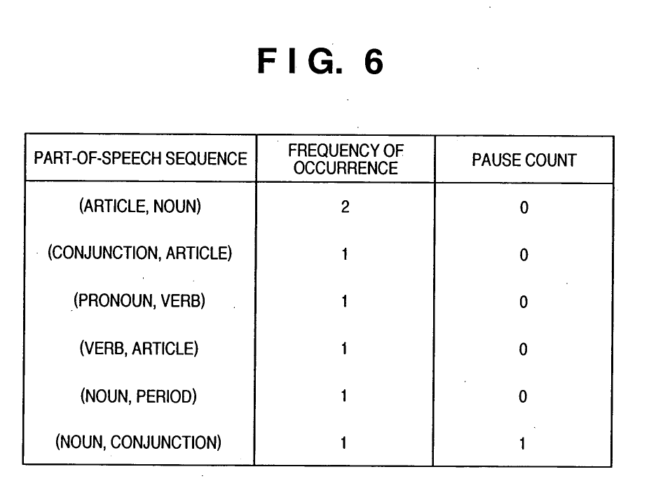

In this way, by applying the processes in steps S206 to S208 to respective word boundaries in the divided sentence, the frequencies of occurrence of arrangements of parts of speech can be obtained for respective groups of part-of-speech sequences with the same arrangements of parts of speech, and the number of pause setting positions between parts of speech can be obtained for respective groups of part-of-speech sequences with the same arrangements of parts of speech. FIG. 6 is a table showing the frequency of occurrence and pause count of each group, which are calculated by applying the aforementioned process to the sentence shown in FIG. 5. Note that such calculation results are temporarily stored in the RAM 102.

Upon completion of the processes for all sentences included in the text corpus, the flow advances to step S210. Pause insertability Pause(PosA, PosB) is calculated for each part-of-speech sequence (PosA, PosB) by:
Pause(PosA, PosB)=PauseCount(PosA, PosB)/PauseSequence(PosA, PosB)

The calculated Pause(PosA, PosB) data may be temporarily stored in the RAM 102 or may be saved in the external storage device 106.

Note that the value of Pause(PosA, PosB) assumes a real number ranging from 0 to 1. For example, Pause(PosA, PosB) may be multiplied by 127, and may be expressed by a value quantized to an integer value ranging from 0 to 127. However, the expression method of Pause(PosA, PosB) is not particularly limited.

As for the text corpus appended with the pause insertion positions, which is used as an input in step S201, sentences in the corpus may be used intact, or sentences prepared by removing commas included in the sentences may be used.

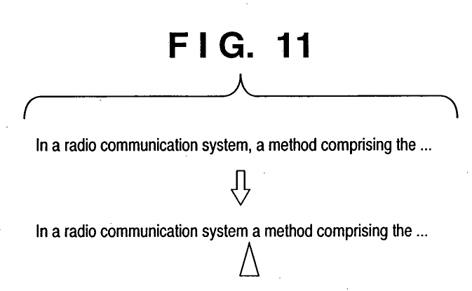

Also, sentences prepared by removing commas from original sentences which appropriately include commas are collected, and the comma positions in the original sentences are considered as pause positions, thus generating a text corpus appended with information associated with the pause insertion positions. FIG. 11 shows such example. A comma between “system” and “a” is deleted from an original sentence, i.e., an upper sentence in FIG. 11 to generate a sentence (a lower sentence in FIG. 11) which has a position where the comma was located as a pause setting position (indicated by a triangular mark). In this manner, a text corpus can be generated by collecting a large number of sentences appended with pause information.

After all the sentences included in the text corpus are processed, and the total frequencies of occurrence and the total pause counts for respective part-of-speech sequences are counted, the process in step S210 can finally obtain the insertabilities of pauses with respect to respective part-of-speech sequences.

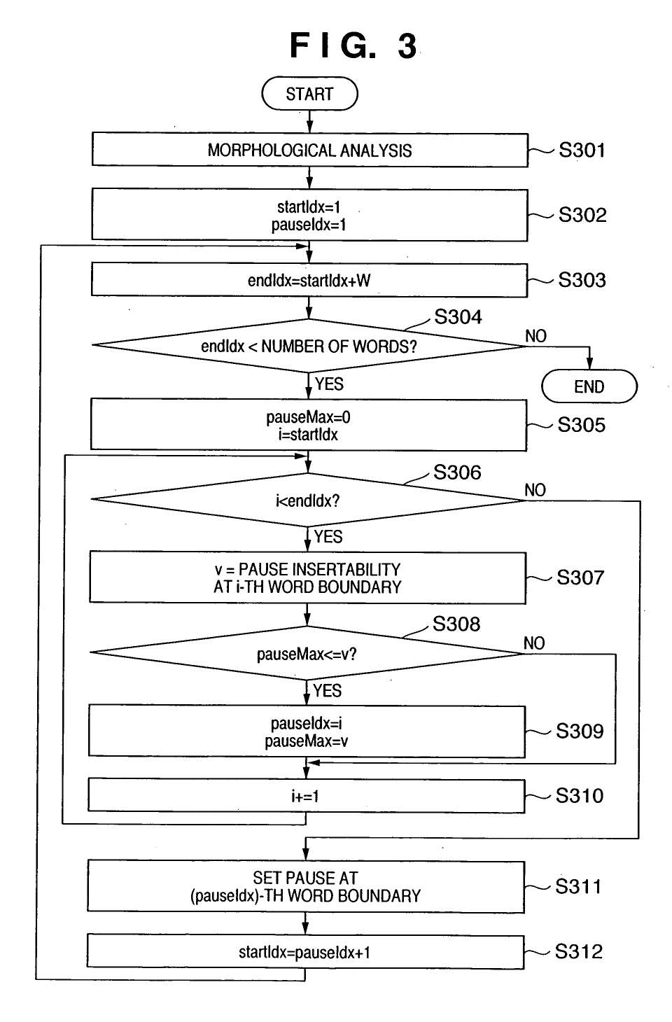

The process for setting a pause in a general sentence using the data indicating the insertabilities of pauses in part-of-speech sequences obtained by the above process, as a natural language process according to this embodiment, will be described below with reference to FIG. 3 which is the flowchart of that process. A program according to the flowchart shown in FIG. 3 is loaded from the external storage device 106 or storage medium drive device 107 onto the RAM 102, and is executed by the CPU 101, so that the natural language processing apparatus according to this embodiment can implement the process to be described below.

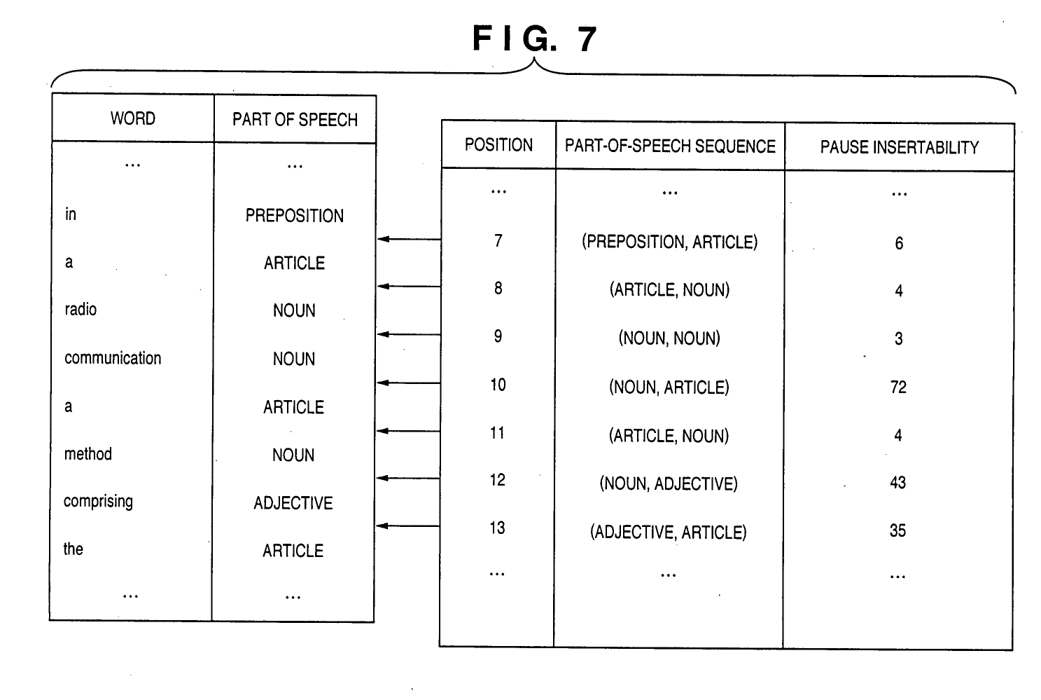

The CPU 101 loads sentence data from the external storage device 106 or storage medium drive device 107 onto the RAM 102 in response to an instruction from the console 104. The CPU 101 applies the morphological analysis process to this sentence to divide that sentence into words and to determine parts of speech of the words (step S301). The columns “word” and “part of speech” in FIG. 7 show an example of the morphological analysis process result in step S301.

The values of variables startIdx and pauseIdx are respectively initialized to “1” (step S302). Also, the value of a variable endIdx is initialized to startIdx +W (step S303). Note that W is a value that gives an indication of a spacing between neighboring pauses, and a specific value is designated in advance. A pause is inserted per approximately W words. In this case, for example, W=7.

The value of the variable endIdx is compared with the number of words divided by the morphological analysis process in step S301 (step S304). That is, it is checked if processes to be described later have been done for all words. If the value of the variable endIdx is smaller than the number of words, i.e., if the processes to be described below have not been done for all words yet, the flow advances to step S305; otherwise, the flow ends.

In step S305, the value of a variable pauseMax is initialized to zero, and the value of a variable i is initialized to the value of the variable startIdx. Next, the value of the variable i is compared with that of the variable endIdx (step S306). That is, it is checked if processes to be described below have been done for all word boundaries from the word boundary position indicated by startIdx to that indicated by endIdx.

If the value of the variable i is smaller than the value of the variable endIdx, i.e., if the processes to be described below have not been done for all word boundaries from the word boundary position indicated by startIdx to that indicated by endIdx yet (one or more unprocessed words still remain), the flow advances to step S307; otherwise, the flow jumps to step S311.

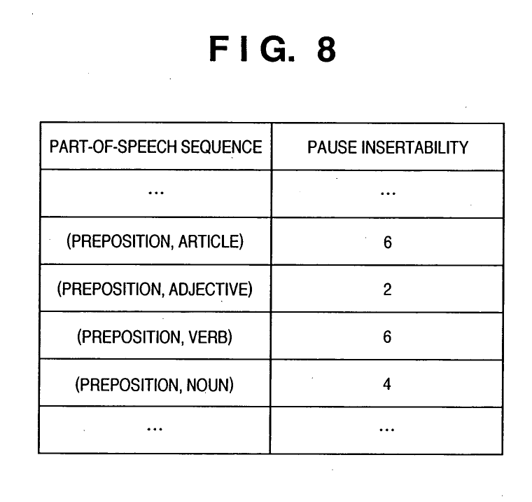

In step S307, a value indicating the pause insertability at the i-th word boundary is substituted in a variable v. For example, the seventh word boundary in FIG. 7 corresponds to a part-of-speech sequence (preposition, article), and a value “6”indicating the pause insertability is substituted in the variable v. Assume that the table that stores values which indicate the pause insertabilities in respective part-of-speech sequences has been prepared in advance by the process shown in FIG. 2. FIG. 8 shows an example of the configuration of the table that stores values which indicate the pause insertabilities in respective part-of-speech sequences. Assume that data of the table shown in FIG. 8 are prepared in advance by the process shown in FIG. 2 mentioned above, and are temporarily stored in the RAM 102 or are saved in the external storage device 106.

Next, the value of the variable pauseMax is compared with that of the variable v (step S308). If the value of the variable pauseMax is equal to or smaller than that of the variable v, the flow advances to step S309; otherwise, the flow jumps to step S310.

In step S309, the value of the variable i is substituted in the variable pauseIdx. Also, the value of the variable v is substituted in the value of the variable pauseMax. The value of the variable i is then incremented by 1 (step S310) to repeat the processes in step S306 and subsequent steps for the next word boundary.

If it is determined in step S306 that the processes in steps S308 to S310 have been done for all the word boundaries from the word boundary position indicated by startIdx to that indicated by endIdx, the flow jumps to step S311 to set a pause at the (pauseIdx)-th word boundary (step S311). Note that the value indicated by the variable pauseIdx indicates a word boundary with a largest pause insertability value by the aforementioned process.

For example, if the value of the variable startIdx is 7 and that of the variable endIdx is 14 in the example of FIG. 7, a pause is set at a word boundary with a largest “pause insertability” value, i.e., the 10 th word boundary (between “communication”and “a”) in this example, of the seventh to 13 th word boundaries. The pause setting process generates data indicating a setting position (the 10 th word boundary position in the example of FIG. 7) as a pause setting position.

The value (the value of the variable pauseIdx+1) is substituted in the variable startIdx (step S312) to repeat the processes in step S303 and subsequent steps. That is, the position where the pause is set is set as new startIdx, and the pause setting process is repeated for the next period (that between startIdx and endIdx).

As described above, since the natural language processing apparatus and natural language processing method according to this embodiment learn pause setting positions on the basis of the arrangements (part-of-speech sequences) of parts of speech of respective words that form a sentence, the pause setting positions can be learned irrespective of the number of commas in a sentence.

Since a pause is set in a general sentence on the basis of such learning result, if the aforementioned learning process is done using a text corpus created based on information actually uttered by a speaker, a pause can be set according to the way to insert a pause unique to the speaker.

In this embodiment, the ratio between PauseCount(PosA, PosB) and PosSequence(PosA, PosB) is calculated to obtain Pause(PosA, PosB). However, the present invention is not limited to such specific calculation method.

[Second Embodiment]

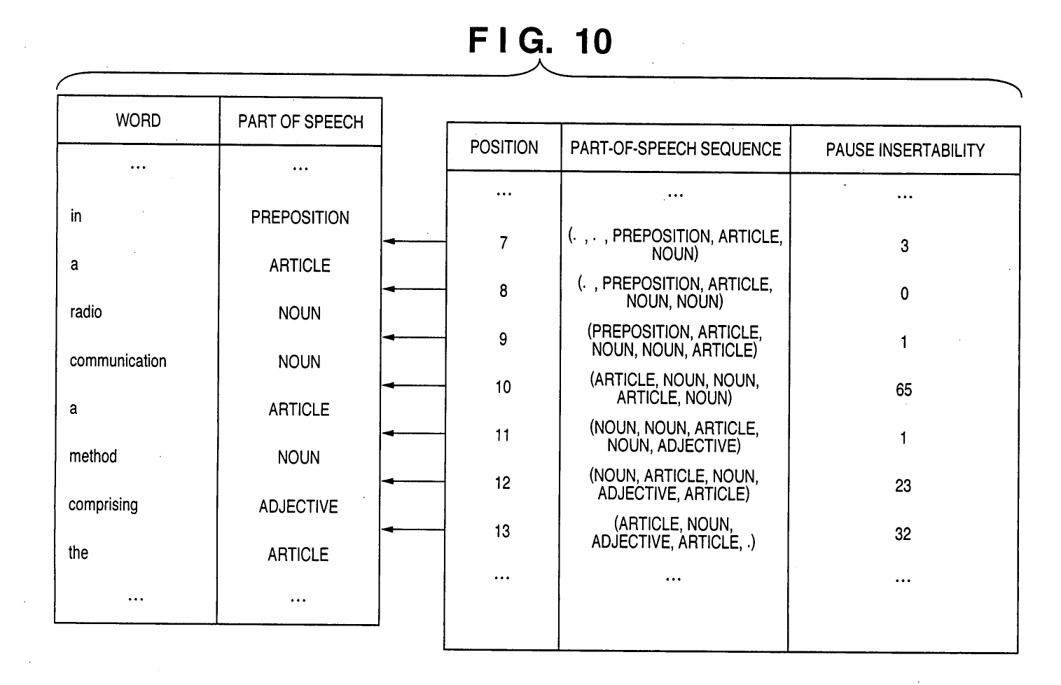

FIG. 10 shows an example when the length of a part-of-speech sequence is 5. This example examines the pause insertability between the third and fourth parts of speech in the part-of-speech sequence with the length=5.

In this case, the pause insertability at the i-th word boundary will be explained below using FIG. 10. For example, a part-of-speech sequence at the 10 th word boundary (between “communication” and “a”) corresponds to that which has an arrangement including parts of speech “a (article)”, “radio (noun)”, and “communication (noun)” of three words before the 10th word boundary, and parts of speech “a (article)” and “method (noun)” after the boundary.

[Other Embodiments]

The objects of the present invention are also achieved by supplying a recording medium (or storage medium), which records a program code of a software program that can implement the functions of the above-mentioned embodiments to the system or apparatus, and reading out and executing the program code stored in the recording medium by a computer (or a CPU or MPU) of the system or apparatus. In this case, the program code itself read out from the recording medium implements the functions of the above-mentioned embodiments, and the recording medium which stores the program code constitutes the present invention.

The functions of the above-mentioned embodiments may be implemented not only by executing the readout program code by the computer but also by some or all of actual processing operations executed by an operating system (OS) running on the computer on the basis of an instruction of the program code.

Furthermore, the functions of the above-mentioned embodiments may be implemented by some or all of actual processing operations executed by a CPU or the like arranged in a function extension card or a function extension unit, which is inserted in or connected to the computer, after the program code read out from the recording medium is written in a memory of the extension card or unit.

When the present invention is applied to the recording medium, that recording medium stores the program codes corresponding to the aforementioned flowcharts.

As described above, according to the present invention, pause rules can be learned irrespective of, e.g., the number of commas.

As many apparently widely different embodiments of the present invention can be made without departing from the spirit and scope thereof, it is to be understood that the invention is not limited to the specific embodiments thereof except as defined in the claims.

1. A natural language processing method comprising:
a reception step of receiving a sentence appended with information associated with a pause setting position;
a part-of-speech acquisition step of acquiring parts of speech of respective words in the sentence;
an acquisition step of acquiring frequencies of occurrence of arrangements of the parts of speech for respective part-of-speech sequence groups with the same arrangements of parts of speech corresponding to arrangements of the words;
a count step of counting the number of pause setting positions each of which is present between parts of speech in the part-of-speech sequence for respective part-of-speech sequence groups on the basis of the information associated with the pause setting position; and
a calculation step of calculating pause insertability values using the frequencies of occurrence and the number of setting positions for respective part-of-speech sequence groups.

2. The method according to claim 1, wherein the calculation step includes a step of calculating each pause insertability value based on a ratio between the frequency of occurrence and the number of setting positions.

3. The method according to claim 1, wherein the information associated with the pause setting position is a comma included in the sentence, and the count step includes a step of counting the number of commas included between parts of speeches in the part-of-speech sequences as the number of pause setting positions.

4. The method according to claim 1, further comprising, in data of a sentence, which is divided into words, parts of speech of which are determined:
a pause setting step of setting a pause in a part-of-speech sequence having a largest pause insertability value calculated in the calculation step of various part-of-speech sequences which are located in a period from a first word boundary to a second word boundary separated a predetermined number of words from the first word boundary, and
in that the pause setting step includes a step of setting a position where the pause is set as a new first word boundary, and repeating pause setting process of the pause setting step for the next period.

5. A natural language processing apparatus comprising:
reception means for receiving a sentence appended with information associated with a pause setting position;
part-of-speech acquisition means for acquiring parts of speech of respective words in the sentence;
acquisition means for acquiring frequencies of occurrence of arrangements of the parts of speech for respective part-of-speech sequence groups with the same arrangements of parts of speech corresponding to arrangements of the words;
count means for counting the number of pause setting positions each of which is present between parts of speech in the part-of-speech sequence for respective part-of-speech sequence groups on the basis of the information associated with the pause setting position; and
calculation means for calculating pause insertability values using the frequencies of occurrence and the number of setting positions for respective part-of-speech sequence groups.

6. A program for making a computer execute a natural language processing method of claim 1.

7. A computer readable storage medium storing a program of claim 6.
